(19) United States
(12) Patent Application Publication
(10) Pub. No.: US 2006/0290946 A1
(43) Pub. Date: Dec. 28, 2006

(54) System and method for measuring roundness

(75) Inventor: Yang-Chang Chien, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/474,170

(22) Filed: Jun. 23, 2006

(30) Foreign Application Priority Data
Jun. 24, 2005 (CN) 200510035551.2

(51) Int. Cl. G01B 11/24

(52) U.S. Cl. 356/613

(57) ABSTRACT

A system (10) for measuring roundness of an object (30), includes a laser-emitting device for emitting a laser beam (123), a driving apparatus (16) for moving the object with respect to the laser beam, a photodetector unit (141) and a processor (143). The photodetector unit receives the laser beam crossing the object, detects a light intensity of the laser beam and transmits an electrical signal representing the light intensity which is in association with the roundness of the object. The processor receives the electrical signal and obtains a roundness signal from the object. A method for measuring roundness of an object is also provided.

### CROSS-REFERENCE TO RELATED APPLICATIONS

Relevant subject matter is disclosed in co-pending U.S. Patent Applications entitled “VIBRATION MEASURING AND MONITORING SYSTEM”, recently filed with the same assignee as the instant application and with the Attorney Docket No.US6954. The disclosure of the above identified application is incorporated herein by reference.

### TECHNICAL FIELD

The present invention generally relates to systems and methods for measuring roundness, and more particularly to a system and a method for measuring roundness based on laser scanning.

### BACKGROUND

Roundness error is one factor affecting the surface quality of a workpiece and needs to be accurately measured. Rotational roundness measuring instrument and V-type roundness measuring instrument are two types of system well known in the art to measure variations in roundness of a workpiece. However, rotational roundness measuring instrument require a high accuracy rotational axis to precisely measuring roundness which increases the cost of manufacturing the instrument. In addition, rotational roundness measuring instrument is not suitable for measuring a relative large or long workpiece. V-type roundness measuring instrument also have relatively low accuracy. Moreover, these two instruments both use contact probe devices contacting a workpiece to determine roundness. Therefore, they are not suitable to measure a workpiece which cannot be touched because it is, for example, sensitive, hot, elastic or the like. Furthermore, the probe is subject to wear and may deform or even damage the part being measured.

What is needed, therefore, is a system and a method for measuring roundness with high accuracy.

### SUMMARY

In one aspect, a system for measuring roundness of an object is provided. The system includes a laser beam, a driving apparatus for moving the object with respect to the laser beam, a photodetector unit and a processor. The photodetector unit receives the laser beam which passes the object, detects a light intensity of the laser beam and transmits an electrical signal representing the light intensity which associated with the roundness of the object. The processor receives the electrical signal and obtains a roundness signal of the object.

In another aspect, a method for measuring roundness of an object is provided. The method includes the steps of: providing a laser beam; moving the object within the laser beam while light intensity of the laser beam crossing the object is changed with the movement of the object and is in association with the roundness of the object; providing a photodetector unit to receive the laser beam and transmit an electrical signal represent the light intensity of the laser beam; providing a processor to receive the electrical signal and obtain a roundness of the object.

Other advantages and novel features will become more apparent from the following detailed description when taken in conjunction with the accompanying drawings.

### BRIEF DESCRIPTION OF THE DRAWINGS

Many aspects of the present system and method for measuring roundness can be better understood with reference to the following drawings. The components in the drawings are not necessarily drawn to scale, the emphasis instead being placed upon clearly illustrating the principles of the system and method for roundness measurement. Moreover, in the drawings, like reference numerals designate corresponding parts throughout the several views.

FIG. 1 is a schematic view of a roundness measurement system according to a preferred embodiment;

FIG. 2 is a schematic view of a laser-emitting device in FIG. 1;

FIG. 3 is an electric field distribution characteristic view of a Gaussian laser beam;

FIG. 4 is a schematic, laser scanning view of the roundness measurement system;

FIG. 5 is a light intensity distribution characteristic curve of the Gaussian laser beam; and

FIG. 6 is an integrated light intensity view of the Gaussian laser beam.

### DETAILED DESCRIPTION OF THE PERFERRED EMBODIMENT

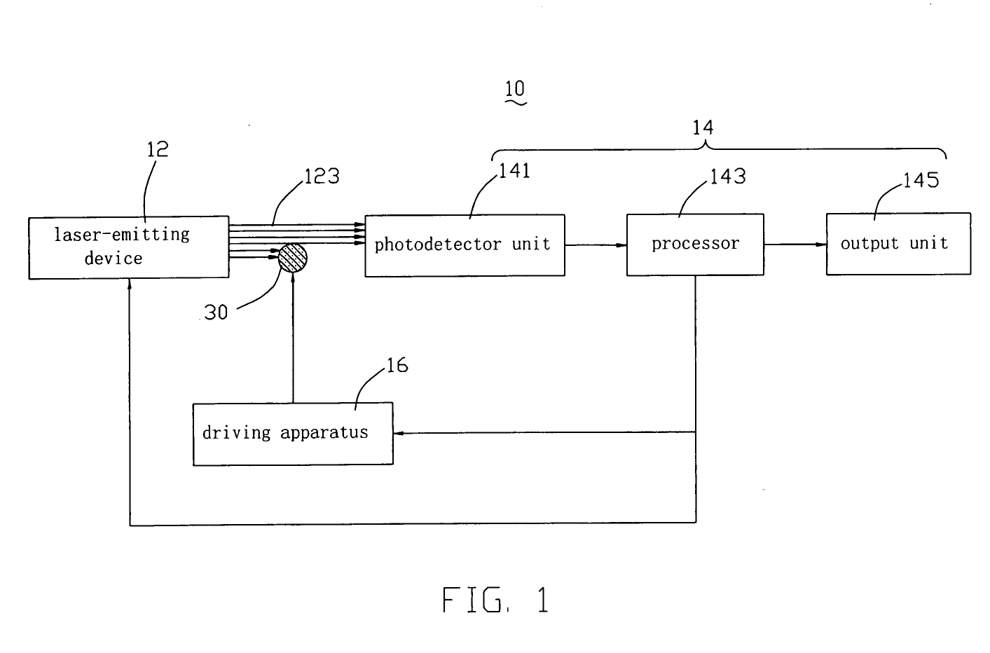

Referring to FIG. 1, in a preferred embodiment, a system 10 is used to measure roundness of a workpiece 30. The system 10 includes a laser-emitting device 12 configured for emitting a laser beam 123, a determining apparatus 14 directed to the laser-emitting device 12 for receiving laser beam 123, and a driving apparatus 16 adapted for supporting the workpiece 30 between the laser-emitting device 12 and the determining apparatus 14, and driving the workpiece 30 to move in a predetermined manner.

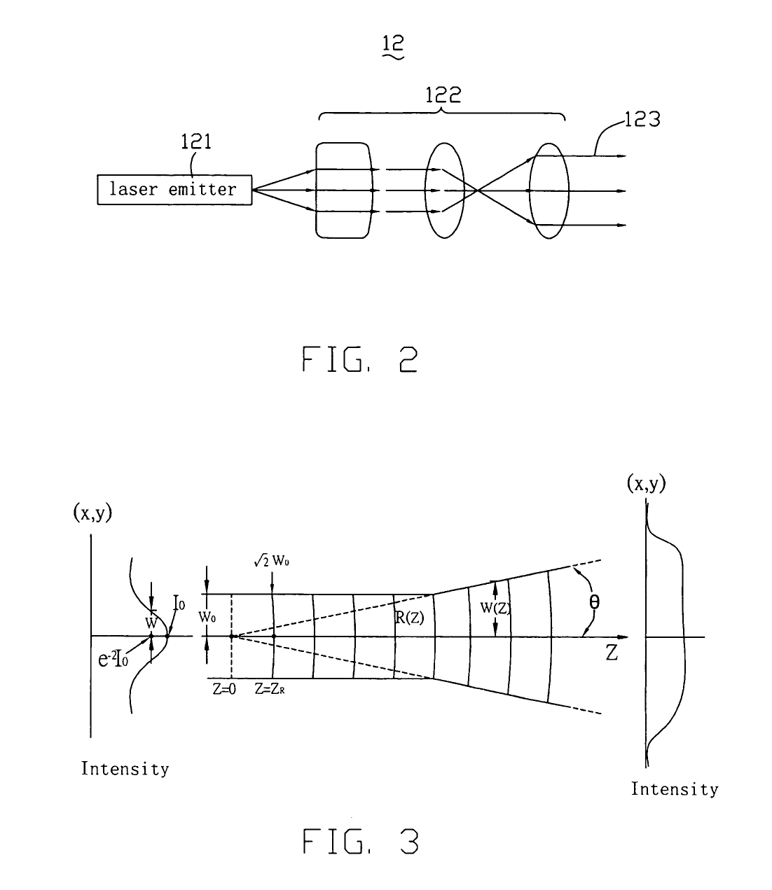

As regards to FIG. 2, the laser-emitting device 12 includes a laser emitter 121 and a set of lenses 122. The laser emitter 121 can be a conventional gas laser emitter, preferably, a neon-xenon gas laser emitter. The lenses 122 are set in a light path of the laser emitter 121 to cooperatively form the laser beam 123. The laser beam 123 has a circular distribution of light energy across a transverse cross-section thereof. The laser beam 123 is preferably a Gaussian laser beam.

The determining apparatus 14 includes a photodetector unit 141, a processor 143 and an output unit 145. The photodetector unit 141, which corresponds to the laser- emitting device 12, receives laser beam 123 and is designed to emit an electrical current signal representative of the light intensity of the laser beam 123. The processor 143, which is typically a computer system or a micro-processor, electronically connected both with the laser-emitting device 12 and the driving apparatus 16 to control them. The processor 143 further can obtain a roundness parameter by analyzing the received electrical current signal. The output unit 145 is connected to the processor 143 for outputting the roundness parameter. The output unit 145 may be a monitor, a printer, or an alarm system.

The driving apparatus 16 is configured for supporting the workpiece 30, and driving the workpiece 30 to rotate about an axis of the workpiece 30 and longitudinally move along the axis of the workpiece 30 under the control of the processor 143. The workpiece 30 mounted on the driving apparatus 16 is in a direction substantially perpendicular to a propagation direction of the laser beam 123 and partially interdicts (or eclipses, blocks etc.) the laser beam 123.

In use, the workpiece 30 is mounted on the driving apparatus 16. When the processor 143 receives a signal instructing it to start measuring the roundness of the workpiece 30, the processor 143 transmits a signal to the laser-emitting device 12 and the driving apparatus 16. The laser-emitting device 12 then begins to emit a laser beam 123 and the driving apparatus begins to drive the workpiece 30 to rotate about its axis. Since the workpiece 30 partially interdicts the laser beam 123 and is rotated about its axis, the photodetector unit 141 receives the laser beams 123 crossing the workpiece 30 whose light intensity changes in association with variations in the roundness of the workpiece 30 and outputs an electrical current signal representative of the light intensity. The processor 143 receives and analyzes the electrical current signal, obtains a roundness parameter, and actuates the output unit 145 to show the obtained roundness parameter. After measuring the roundness of a first contour of the workpiece 30, the driving apparatus 16 stops rotating the workpiece 30 and drives the workpiece 30 to move longitudinally a distance, then continually drives the workpiece 30 to rotate, in order to measure a roundness of a second contour of the workpiece 30.

The system 10 uses a laser knife edge principle to measure roundness. Referring to FIGS. 3 to 6, the laser beam 123, which is a Gaussian laser beam, has an electric field amplitude can be described by equation-1 shown below.

$$\begin{matrix}E ( r , z ) = {E}_{0} \frac{{W}_{0}}{W ( z )} \times exp ( - \frac{{r}^{2}}{{W}^{2} ( z )} ) & ( a ) \\ \times exp \{ - j [ kz - tan ( \frac{z}{{z}_{R}} ) ] \} & ( b ) \\ \times exp [ - j k \frac{{r}^{2}}{2 R ( z )} ] & ( c )\end{matrix} \qquad ( equation \text{-} 1 )$$

, where r is the distance from the center of the laser beam, and r=\sqrt{x²+y²} wherein x and y are two coordinate dimensions;
z is the distance along the laser beam from laser beam's waist;
j is the imaginary unit;
E₀ is the electric field amplitude at the center of the laser beam at its waist;
W₀ is the beam waist radius;
z_{R} is defined as a Rayleigh range, where

$${z}_{R} = \frac{π {W}_{0}^{2}}{λ} ;$$
k is the wave number, and

$$k = \frac{2 π}{λ}$$
where λ is the wavelength of the material in which the laser beam propagates;
W(z) is the spot size of the laser beam at position z; and
R(z) is the curvature radius of the wavefronts.

The first item (a) in equation-1 shows an amplitude factor representing a relationship between the laser beam 123 and parameter r. The second item (b) represents a phase change when the laser beam 123 is transmitted along a longitudinal direction. The third item (c) represents a phase change when the laser beam 123 is transmitted along a radial direction.

The spot size W(z) can be described by equation-2 as follows. The curvature radius of the wavefronts R(z) can be described by equation-3 as follows.

$$\begin{matrix}W ( z ) = {{W}_{0} [ 1 + {( \frac{λ z}{π {W}_{0}^{2}} )}^{2} ]}^{\frac{1}{2}} = {{W}_{0} [ 1 + {( \frac{z}{{z}_{R}} )}^{2} ]}^{\frac{1}{2}} & ( equation \text{-} 2 ) \\ R ( z ) = z [ 1 + ( \frac{π {W}_{0}^{2}}{λ} ) ] = z [ 1 + {( \frac{{z}_{R}}{z} )}^{2} ] & ( equation \text{-} 3 )\end{matrix}$$

At position z=0, corresponding to the beam waist, it can be obtained by using equation-2 and equation-3 that W(0)=W₀ and R(0)→∞. The spot size W(z) is at its minimum and the phase profile is flat.

At position z=z_{R}, it could be obtained from equation-2 and equation-3 that W(z_{R})=\sqrt{2}(W₀) and R(z_{R})=2z_{R}. The area of the spot size is twice the waist area and the curvature radii is at its minimum.

At position z>>z_{R}, it could be obtained from equation-2 and equation-3 that R(z)≈z and

$$W ( z ) \approx \frac{λ z}{π {W}_{0}} .$$

The beam divergence angle θ approximately is given by equation-4.

$$θ = \frac{ⅆ W ( z )}{ⅆ z} = \frac{{W}_{0}}{{z}_{R}} = \frac{λ}{π {W}_{0}} \qquad ( equation \text{-} 4 )$$

Thus it can be concluded that the characteristics of a Gaussian laser beam 123 are defined by the beam waist radius W₀ and the wave length λ of the laser beam 123.

Since the electric field of the laser beam 123 varies rapidly, it can be used to measure the light intensity of the laser beam 123. The light intensity of the laser beam 123 is given by equation-5 in a rectangular coordinate as follows.

$$I = E \times {E}^{*} = {I}_{0} exp ( \frac{- 2 [ {( x - {x}_{0} )}^{2} + {( y - {y}_{0} )}^{2} ]}{{W}^{2}} ) \qquad ( equation \text{-} 5 )$$

, where position (x₀, y₀) is the center of the laser beam;
I₀ is the light intensity of the laser beam at position (x₀,y₀), and I₀=Iₘₐₓ; and
W is the spot size of the laser beam at which the intensity I₀ drops to e⁻²I₀ (e⁻²≈0.1353).

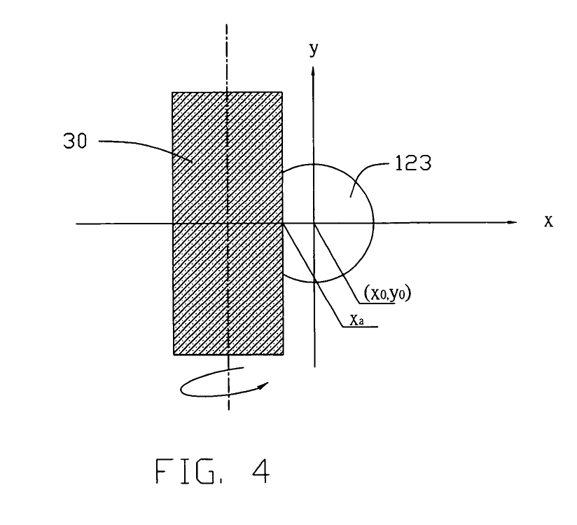

Referring to FIG. 1 and FIG. 4, assuming that a scanning direction of the measurement system 10 is along the x axis, thus intensity of the part of the laser beam 123 which passes the workpiece 30 and detected by the photodetector unit 141 is defined by the following equation-6.

$$\begin{matrix}S ( {x}_{a} ) = {\int }_{- ∞}^{∞} {\int }_{{x}_{a}}^{∞} I ( x , y ) ⅆ x ⅆ y \\ = {\int }_{- ∞}^{∞} {\int }_{{x}_{a}}^{∞} {I}_{0} exp \{ \frac{- 2 [ {( x - {x}_{0} )}^{2} + {( y - {y}_{0} )}^{2} ]}{{W}^{2}} \} ⅆ x ⅆ y \\ = {{I}_{0} ( \frac{π {W}^{2}}{2} )}^{\frac{1}{2}} {\int }_{{x}_{a}}^{∞} exp \{ \frac{- 2 {( x - {x}_{0} )}^{2}}{{W}^{2}} \} ⅆ x\end{matrix} \qquad ( equation \text{-} 6 )$$

where
xₐ, is a distance between a periphery of the workpiece 30 and position x₀ along x axis.

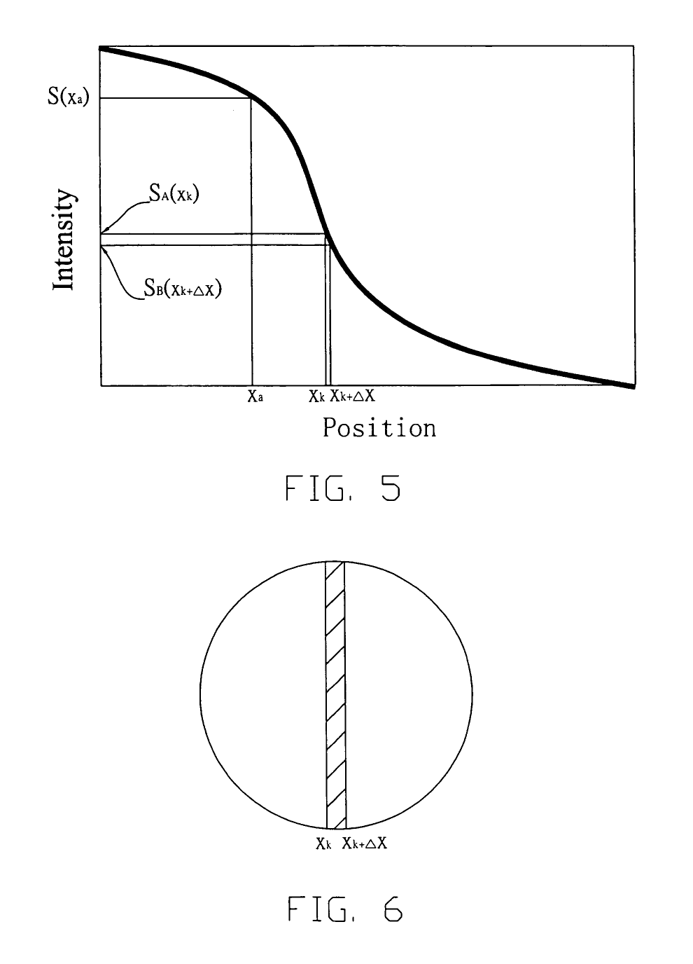

FIG. 3 is a map of a light intensity distribution of the laser beam 123 obtained from equation-6. FIG. 5 shows the light intensity distribution characteristic curve of the Gaussian laser beam. A light intensity difference between a position xₖ and another position xₖ+Δx of the laser beam 123 is given by equation-7 as follows. The light intensity difference is regarded as an integrated intensity shown in FIG. 6.
S_{A}(xₖ)−S_{B}(xₖ+Δx)+∫_{∞}^{∞}∫ₓ_{ₖ}_{+Δ}_{ₓ}^{x} ^{ₖ}I(x, y)dxdy (equation-7)

The light intensity S(xₐ) can be normalization when the total light intensity S(∞) of the laser beam 123 is divided by the S(xₐ), which is represented in equation-8.

$$\overline{S} ( {x}_{a} ) = \frac{S ( {x}_{a} )}{S ( ∞ )} = {( \frac{2}{π {W}^{2}} )}^{\frac{1}{2}} {\int }_{{x}_{a}}^{∞} exp [ \frac{- 2 ( x - {x}_{0} )}{W} ] ⅆ x \qquad ( equation \text{-} 8 )$$

It can therefore be seen that, the system 10 uses the photodetector unit 141 to detect the light intensity changes of the laser beam 123. The photodetector unit 141 transforms the light intensity changes to an electric signal, and the processor 143 obtains a roundness of the workpiece 30 by analyzing the electric signal using equation-7 and equation-8.

The system 10 measures roundness based on laser scanning and therefore does not involve physical contact with the workpiece 30, thus avoiding complications caused by contact with the workpiece 30. In addition, since laser beam 123 does not touch the workpiece 30 and the workpiece 30 cannot become torn or deformed, the accuracy of the measurement can be improved.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A system for measuring roundness of an object, comprising:
a laser-emitting device configured for emitting a laser beam;
a driving apparatus configured for moving the object relative to the laser beam;
a photodetector unit configured to receive the laser beam crossing the object, detect a light intensity of the laser beam and transmit an electrical signal representing the light intensity which is in association with the roundness of the object;
a processor configured to receive the electrical signal and obtain a roundness signal of the object.

2. The system as claimed in claim 1, wherein the laser beam is a Gaussian laser beam which has a circular distribution of light energy across a transverse cross-section thereof.

3. The system as claimed in claim 2, wherein the laser-emitting device comprises a laser emitter and at least one lens set in a light path of the laser emitter.

4. The system as claimed in claim 3, wherein the laser emitter is a gas laser emitter.

5. The system as claimed in claim 1, further comprises an output unit electronically connects to the processor to show the roundness of the object.

6. The system as claimed in claim 1, wherein the driving apparatus is configured for rotating the object.

7. The system as claimed in claim 6, wherein the driving apparatus is further configured for longitudinally moving the object.

8. The system as claimed in claim 6, wherein the processor electronically connects to the driving apparatus to control the driving apparatus.

9. A method for measuring roundness of an object, comprising the steps of:
providing a laser beam;
moving the object within the laser beam while light intensity of the laser beam crossing the object is changed by the movement of the object and is in association with the roundness of the object;
providing a photodetector unit to receive the laser beam and transmit an electrical signal representing the light intensity of the laser beam;
providing a processor to receive the electrical signal and obtain a roundness measurement of the object.

10. The method as claimed in claim 9, wherein moving the object within the laser beam comprises rotating the object within the laser beam.

11. The method as claimed in claim 9, wherein the object is moved within the laser beam to partially eclipse the laser beam.
